(19) United States
(12) Patent Application Publication
(10) Pub. No.: US 2018/0114221 A1
(43) Pub. Date: Apr. 26, 2018

(54) SECURE PAYMENT

(71) Applicant: ISX IP Ltd., Tortola (VG)

(72) Inventor: Nickolas John Karantzis, East Melbourne, NSW (AU)

(21) Appl. No.: 15/575,767

(22) PCT Filed: May 25, 2016
(86) PCT No.: PCT/AU2016/050401

§ 371 Date: Nov. 20, 2017

(30) Foreign Application Priority Data
May 25, 2015 (AU) 2015901908

(51) Int. Cl. G06Q 20/40; G06Q 20/32; G06K 19/07

(52) U.S. Cl. CPC G06Q 20/40; G06Q 20/3227; G06K 19/0723; G06Q 20/4014; G06Q 20/3224

(57) ABSTRACT

There is provided a computer-implemented method for making a payment transaction. The method comprises receiving (510) payment information from a first party of the transaction, the payment information including a first portion of authentication information of a financial instrument from which the payment is to be made; determining (520) a second portion of the authentication information; determining (530) the authentication information of the financial instrument based on the first portion and the second portion of the authentication information; and causing (540) the payment to be made from the financial instrument by using the authentication information.

### CROSS-REFERENCE TO RELATED APPLICATIONS

The present application claims priority from the Australian provisional application 2015901908 filed on 25 May 2015 with iSignthis Ltd being the applicant and the contents of which are incorporated herein by reference.

### TECHNICAL FIELD

The present disclosure generally relates to a secure payment mechanism. The present disclosure includes computer-implemented methods, software, and computer systems for making a payment transaction.

### BACKGROUND

Card-Not-Present (CNP) transactions enable a user to purchase goods or services from a merchant without presenting a physical financial instrument, for example, a credit card or a debit card, from which a payment transaction is to be made. In a CNP transaction, authentication information of the financial instrument is usually provided from the user to the merchant or the merchant's financial institution where the authentication information is processed in order to make the payment. Although the CNP transaction makes it convenient for the user to make the payment transaction, this leads to a risky situation where the authentication information of the financial instrument is exposed to several third parties, in particular the merchant and the personnel of the merchant. Therefore, it is desirable to improve security of CNP transaction.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Any discussion of documents, acts, materials, devices, articles or the like which has been included in the present disclosure is not to be taken as an admission that any or all of these matters form part of the prior art base or were common general knowledge in the field relevant to the present disclosure as it existed before the priority date of each claim of this application.

### SUMMARY

There is provided a computer-implemented method for making a payment transaction, said method comprising:

receiving payment information from a first party of the transaction, the payment information including a first portion of authentication information of a financial instrument from which the payment is to be made;

determining a second portion of the authentication information;

determining the authentication information of the financial instrument based on the first portion and the second portion of the authentication information; and

causing the payment to be made from the financial instrument by using the authentication information.

It is an advantage of the present disclosure that the authentication information of the financial instrument is not stored in a single location and determined from multiple portions of the authentication information without the need of presenting the financial instrument. This may meet the financial regulation requirements and provide the convenience of CNP transaction at the same time. Further, the authentication information of the financial instrument is not exposed to the payee, this may reduce the risk of the authentication information being available to third parties. Using the present disclosure, the necessity of investing in expensive security equipment as outlined by the Payment Card Industry Data Security Standard (PCI DSS) may no longer exist. Further, security protocols such as Hypertext Transfer Protocol Security (HTTPS) may not be needed as the complete authentication information of the financial instrument is not exposed to the payee.

The first party of the transaction may be a payer of the transaction.

Receiving the payment information may comprise receiving the payment information from a mobile device securely associated with the payer.

The methods described above may further comprise:

establishing an account associated with the payer, the account being identified by identification information of the mobile device; and

associating the account with the second portion of the authentication information of the financial instrument.

The methods described above may further comprise determining that the payer is authorised to use the financial instrument.

The methods described above may further comprise:

receiving a request for access to the account to make the payment, the request including the identification information of the mobile device;

allowing access to the account identified by the identification information of the mobile device.

The methods described above may further comprise associating the account with authentication information of the payer.

The authentication information of the payer may comprise at least one of:

a combination of a username with a password;

biometrics information of the payer; and

a One-Time-Password (OTP) accessible by the payer.

The methods described above may further comprise:

receiving a request for access to the account to make the payment, the request including the authentication information of the payer;

allowing access to the account associated with the authentication information the payer.

The methods described above may further comprise:

associating the account with a contact of the payer; and

send a message to the contact of the payer to invite the contact to establish an account according to the method.

The methods described above may further comprise:

associating the account with location data for use in assessing fraud risk.

The methods described above may further comprise:

receiving location data indicating a geographic location of the mobile device;

determining a risk level based on the received location data and the location data associated with the account.

The location data associated with the account may comprise at least one of:

an address indicating a geographic area;

a mobile phone cell tower location;

geographical coordinates associated with a fixed WIFI node;

geographical coordinates associated with a fixed beacon;

an Internet Protocol (IP) address; and

Global Positioning System (GPS) data.

Determining the second portion of the authentication information of the financial instrument may comprise retrieving the second portion of the authentication information from a storage unit.

Determining the authentication information of financial instrument may comprise combining the first portion with the second portion of the authentication information of financial instrument.

The payment information may comprise transaction information associated with the transaction.

There is provided a computer-implemented method for making a payment transaction, said method comprising:

determining a portion of authentication information of a financial instrument from which the payment is to be made;

receiving transaction information associated with the transaction;

sending payment information including the portion of authentication information and the transaction information to a payment service processor to determine the authentication information of the financial instrument and cause the payment to be made from the financial instrument.

It is an advantage of the present disclosure that only the portion of the authentication information is provided to the payment service provider when making the payment transaction. This may reduce the risk of the authentication information being available to an unauthorised user during the transaction. On the other hand, the authentication information of the financial instrument is not stored in a single location and determined from multiple portions of the authentication information. This may meet the payment card industry requirements, and/or financial regulation requirements whilst providing the convenience of CNP transaction at the same time.

Determining the portion of the authentication information may comprise retrieving the portion of the authentication information from a mobile device securely associated with a user of the financial instrument.

Determining the portion of the authentication information may comprise receiving the portion of the authentication information from a user interface.

The user interface may comprise:

a keyboard;

a Near Field Communication (NFC) interface; and

an optical reader.

Receiving the transaction information may comprise obtaining the transaction information from a message.

The message may comprise an instant message, a short message, a multimedia message, and an E-mail.

Receiving the transaction information may comprise obtaining the transaction information from a token in which the transaction information is coded.

The token may be a computer-readable mark presented on a medium.

Obtaining the transaction information comprises scanning the computer-readable mark for the transaction information.

The medium may comprise:

a screen on which the computer-readable mark is displayed; and

a material on which the computer-readable mark is printed or projected.

The computer-readable mark may comprise:

a barcode; and

a Quick Response (QR) code.

Obtaining the transaction information from the token may comprise receiving the token via one of the following means:

Near Field Communication (NFC);

Radio Frequency Identification (RFID) tags;

Wireless Local Area Network (WLAN);

Bluetooth;

Wireless Cellular Network;

Internet; and

Online streaming service.

The token may be generated by a payee of the transaction.

The transaction information may comprise augmented reality data, which may be received optically, or via radio communications, including Bluetooth, WiFi, NFC or other means.

The methods described above may further comprise:

obtaining the augmented reality data from the transaction information; and

presenting the augmented reality data to a user of the financial instrument.

There is provided a computer system for making a payment transaction, the computer system comprising:

a communication port to receive payment information from a first party of the transaction, the payment information including a first portion of authentication information of a financial instrument from which the payment is to be made; and

a processor comprises:
an authentication unit to
determine a second portion of the authentication information the financial instrument; and
determine the authentication information of the financial instrument based on the first portion and the second portion of the authentication information; and
a payment unit to cause the payment to be made from the financial instrument by using the authentication information.

There is provided a computer system for making a payment transaction, the computer system comprises:

a communication port to receive transaction information associated with the transaction; and

a processor comprises:
an authentication unit to determine a portion of authentication information of a financial instrument from which the payment is made; and
a payment unit to send payment information including the portion of authentication information and the transaction information to a payment service processor to determine the authentication information of the financial instrument and cause the payment to be made from the financial instrument.

There is provided a computer software program, including machine-readable instructions, when executed by a processor, causes the processor to perform the method as described above where appropriate.

There is provided a computer software program, including machine-readable instructions, when executed by a processor, causes the processor to perform the method as described above where appropriate.

### BRIEF DESCRIPTION OF THE DRAWINGS

Features of the present disclosure are illustrated by way of non-limiting examples, and like numerals indicate like elements, in which:

FIG. 1 illustrates an example payment system in accordance with the present disclosure;

FIG. 2 illustrates an example structure of a user database in accordance with the present disclosure;

FIG. 3 illustrates an example method for making a payment transaction in accordance with the present disclosure;

FIGS. 4(a) to (h) illustrate example user interfaces for making a payment transaction in accordance with the present disclosure;

FIG. 5 illustrates an example method for making a payment transaction in accordance with the present disclosure;

FIG. 6 illustrates an example schematic diagram of a computer system for making a payment transaction in accordance with the present disclosure; and

FIG. 7 illustrates an example schematic diagram of a computer system for making a payment transaction in accordance with the present disclosure.

### BEST MODES OF THE PRESENT DISCLOSURE

System Description

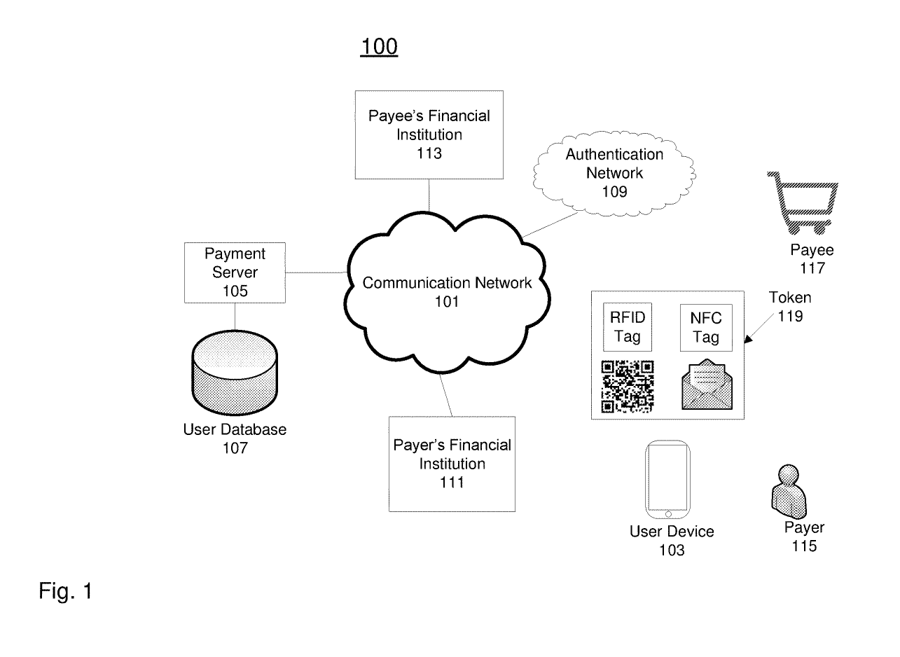

FIG. 1 illustrates an example payment system 100 in accordance with the present disclosure.

The payment system 100 includes a communication network 101, a user device 103, a payment server 105, a user database 107, an authentication network 109, a payer's financial institution 111, a payee's financial institution 113. The payment system 100 provides payment services between a payer 115 and a payee 117.

The communication network 101 is a network that communicates information between the network elements in the system 100, which may be for example a local area network (LAN), a wireless local area network (WLAN), a wide area network (WAN), a cellular telecommunication network, the internet, or a combination thereof.

The user device 103 is a device that the payer 115 uses to make a payment transaction with the payee 117. The user device 103 may be a mobile device that is securely associated with the payer 103, for example, a mobile phone. In most jurisdictions, the legal possession of a mobile phone by a user is an indication that the identity of the user has been verified. The phone number of the mobile phone can be used as a unique identifier (ID) to identify the user. Therefore, the mobile phone 103 in the present disclosure serves the purposes of enhancing security of the payment system 100 and identifying the user. The user device 103 may be other mobile or fixed devices without departing from the present disclosure.

In the present disclosure, the payer 115 associates a financial instrument, for example, a credit card, with the mobile phone 103 from which the payment is to be made and stores a portion of authentication information of the financial instrument in the mobile phone 103, for example, internal memory or a Subscriber Identity Module (SIM) of the phone mobile 103. The authentication information of the financial instrument is the information authenticated by the authentication network 109 in order to make a payment from the financial instrument. If the financial instrument is a credit card, the authentication information includes a card number, a expiry date, a name on card and a Card Verification Value (CCV) code.

In this example, the portion of authentication information of the financial instrument stored in the mobile phone 103 is the last four digits of the card number of the credit card. When making the payment transaction, the mobile phone 103 receives transaction information associated with the payment transaction, for example, the amount of money to be paid, and the payee's 117 financial institution information. The payee's 117 financial institution information is used to identify the payee's financial account that receives the payment, which may include the payee's 117 bank name, account name, and account number, or may reference a merchant identifier (MID) as issued by the card scheme and/or the payee's 117 financial institution. The transaction information may be contained in a token 119 generated by the payee 117. The token 119 can be a computer-readable mark, for example, a barcode or a Quick Response (QR) code. The token 119 may be displayed on a display provided by the payee 117 or printed on the piece of paper, a flyer or a card. In this case, the payer 115 may receive the transaction information by using a barcode reader application running on the mobile phone 103 to read the transaction information from the barcode.

The mobile phone 103 then sends a payment request to the payment server 105. The payment request includes the phone number (“+1 123 456 789”) of the mobile phone 103, the transaction information and the portion of the authentication information of the financial instrument.

The payment server 105 is a computing device that processes the payment request received from the payer 103. In the present disclosure, the payment server 105 creates an account in the user database 107 associated with each of the payers that register with the payment system 100.

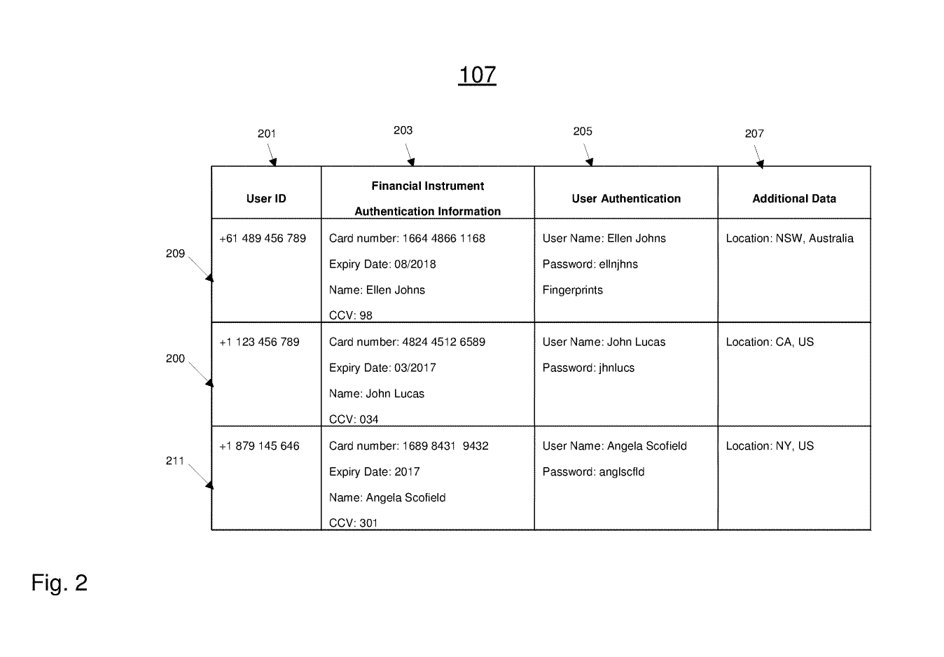

An example structure of the user database 107 is shown in FIG. 2. The user database 107 shown in FIG. 2 includes a “User ID” field 201, a “Financial Instrument Authentication Information” field 203, an “User Authentication” field 205, and an “Additional Data” field 207. The “User ID” field 201 contains unique identifiers of the payers, which may be the phone numbers of the mobile phones of the payers to identify the payers. The “Financial Instrument Authentication Information” field 203 contains the remaining portions of the authentication information of financial instruments, which may be provided by the payers when they register with the payment system 100. The “User Authentication” field 205 and the “Additional Data” field 207 will be described in detail in the later part of this specification.

Upon receipt of the payment request from the payer 115, the payment server 105 extracts the mobile number, i.e., “+1 123 456 789”, from the payment request, and searches the user database 107 by the phone number. As a result, an account associated with the phone number is identified, i.e., an account 200. The payment server 105 then extracts the remaining portion of the authentication information of the financial instrument associated with the account 200 from the “Financial Instrument Authentication Information” field 203 of the account 200.

The remaining portion of the financial instrument may for example be the first twelve digits of the credit card, the expiry date, the name on the card, and the CCV code of the credit card, as shown in FIG. 2. The portions of the authentication information of the financial instrument that are stored in the mobile phone 103 and the user database 107, respectively, may be subject to financial regulation requirements. That is, the examples of the portions used in the present disclosure are for illustration purposes only, which may vary according to financial regulations without departing from the scope of the present disclosure. For example, the CCV code of the credit card may be split into portions, and the portions are stored separately.

The payment server 105 assembles the authentication information based on the portions of the authentication information of the financial instrument, and in turn sends the authentication information along with the transaction information to the authentication network 109. The authentication network 109 is an existing authentication network that performs an authentication process to authenticate the authentication information received from the payment server 105. If the authentication process is successful, the amount of money included in the transaction information is debited from the payer's financial institution 111 to the payee's financial institution 113.

It should be noted that although the network elements in FIG. 1 are shown as separate network elements, one network element may be part of another network element either logically or physically. For example, the user database 107 may be part of the payment server 105.

Further, the link between these network elements may take a variety of forms where appropriate. For example, the link may be a wireline communication link, a wireless communication link, an optical communication link, an access network, or a combination thereof.

Description of an Example Method for Making a Payment Transaction

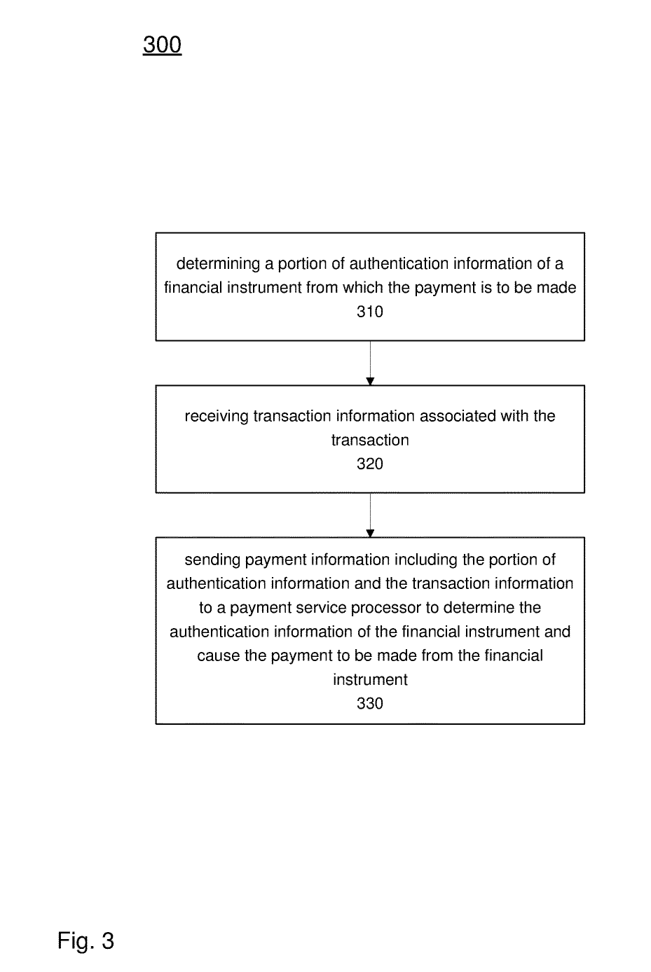

FIG. 3 illustrates an example method 300 for making a payment transaction, which may be performed on the user device 103 of the payer 115.

In the example method 300 illustrated in FIG. 3, when a customer, referred to as the payer 115, intends to make a payment for the goods or services purchased from a merchant, referred to the payee 117, the method 300 determines 310 a portion of authentication information of the financial instrument from which the payment is to be made. The method 300 receives 303 transaction information associated with the transaction. The method 305 then sends payment information including the portion of authentication information and the transaction information to a payment service processor, for example, the payment server 105, to determine the authentication information of the financial instrument and cause the payment to be made from the financial instrument.

A detailed example implementation of the method 300 is described below.

Registering with the Payment Server 105

In this example, in order for the payer 115 to use the payment services provided by the payment server 105, the payer 115 needs to register with the payment server 105. The registration with the payment server 105 may be conducted before or when the payment transaction is made.

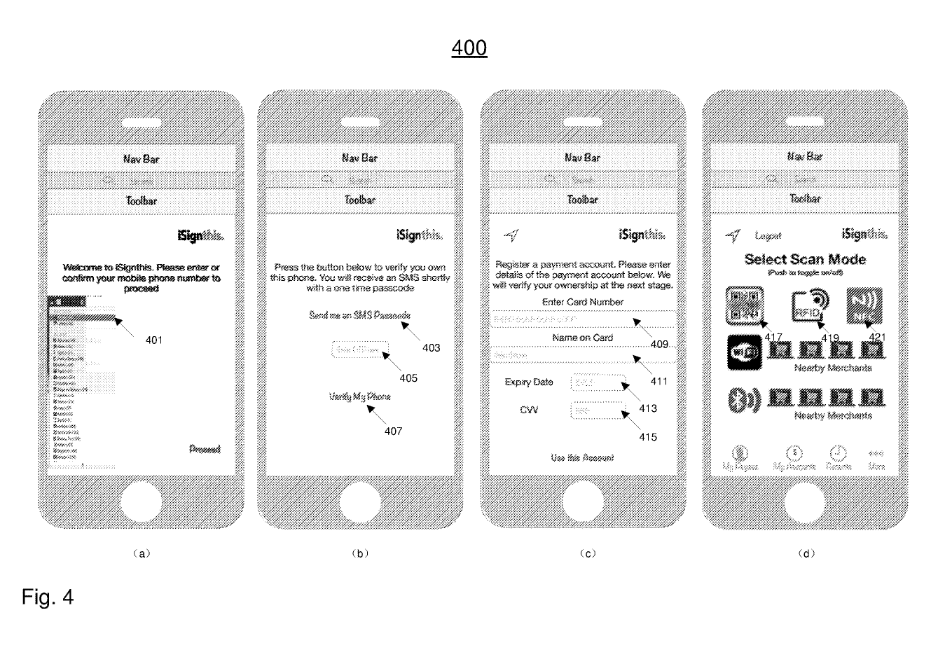

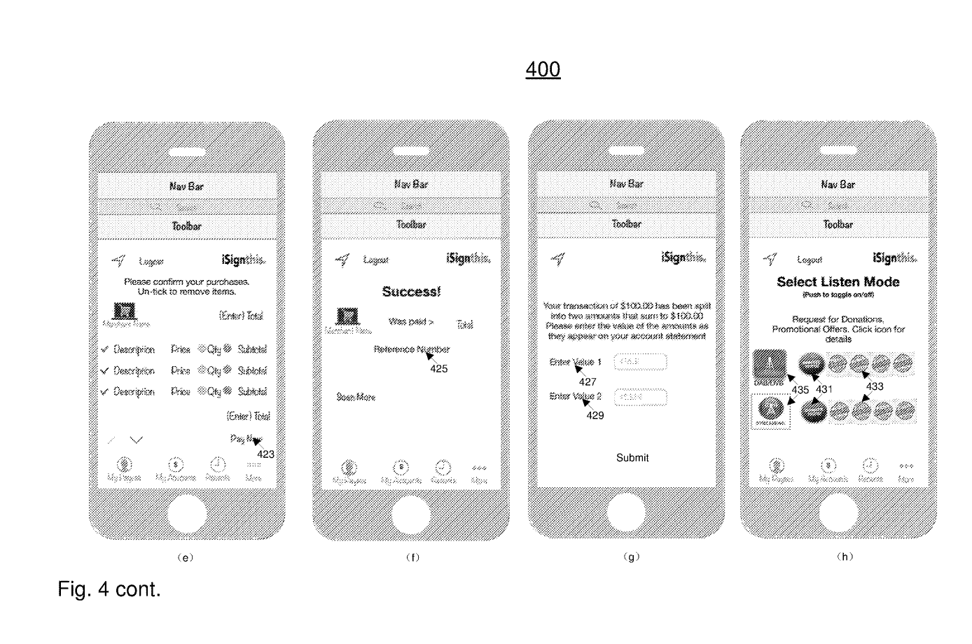

FIGS. 4(a) to (c) shows an example process 400 for the payer 115 to register with the payment server 105. When registering with the payment server 105, the payer 115 is asked to provide the payment server 105 with a phone number 401 (“+1 123 456 789”) of the mobile phone 103 that the payer 115 is using or intends to use to make payment transactions, as shown in FIG. 4(a).

After the payer 115 provides the phone number 401, the payer 115 requests 403 a One-Time-Password (OTP) to verify that the payer 115 owns the mobile phone 103, as shown in FIG. 4(b). The OTP, which is a temporary password and known to the payment server 105, may be contained in an instant message or short message sent to the mobile phone 103 via a mobile internet or cellular telephone network respectively. The OTP may be generated by the payment server 105 or a third-party. Upon receipt of the OTP at the mobile phone 103, the payer 115 enters the OTP into the text box 405 and clicks on “verify my phone” 407. If the OTP entered by the payer 115 matches the OTP known to the payment server 105, which means the ownership of the mobile phone 103 is verified, the payment server 105 creates the account 200 for the payer 115 in the user database 107 and stores the phone number 401 of the payer 115 in the “User ID” field 201 of the account 200, as shown in FIG. 2.

For additional security, the payer 115 may further set authentication information of the payer 115, i.e., user authentication information, which is used to authenticate the user for later access to the account 200. In this example, the payer 115 provides a username (“John Lucas”) and a password (“jhnlucs”) for the account 200 as the authentication information of the payer 115 to the payment server 105. The payment server 105 stores the user name and the password in the “User Authentication” field 205 of the account 200, as shown in FIG. 2.

The authentication information of the payer 115 can be information other than a combination of a user name and a password. Particularly, the authentication information may be biometrics information of the payer 115, for example, a facial image, fingerprints, retina image or heartbeat of the payer 115, which may be captured by suitable sensors on the mobile phone 103. For example, the facial image of the payer 115 may be captured by a camera installed on the mobile phone 103, and the fingerprints of the payer 115 may be captured by a fingerprints sensor on the mobile phone 103.

Further, the authentication information of the payer 115 can also be an OTP. The OTP is generated by the payment server 105 or a third-party when the payer 115 accesses the account 200. The OTP is made accessible by the payer 115 by for example sending a short message including the OTP to the mobile phone 103 of the payer 115. In this case, the OTP may not be stored in the “User Authentication” field 205 of the account 200.

To reduce fraud risks, the payer 115 may further provide additional data to the payment server 105. The additional data may be location data that indicates a geographic area where the payer 115 normally makes payment transactions using the mobile phone 103. In this example, the location data (“CA, US”) indicates that the payer 115 normally make payments in the State of California of the United States. The Location data may include one or more of:

an address indicating a geographic area;

a mobile phone cell tower location;

geographical coordinates associated with a fixed WIFI node;

geographical coordinates associated with a fixed beacon;

an Internet Protocol (IP) address; and

Global Positioning System (GPS) data.

The additional data may also be data that is specific to the mobile phone 103 that the payer 115 is using to register with the payment server 105, which the payer 116 may also intend to use for future payments. The mobile phone-specific data may be International Mobile Subscriber Identity (IMSI), Mobile Subscription Identification Number (MSIN), International Mobile Station Equipment Identity (IMEI), Mobile Country Token (MCT), etc. of the mobile phone 103. The mobile phone-specific data may be recognised automatically during registration and is sent to the payment server 105 to be stored in the “Additional Data” field 207 of the account 200, as shown in FIG. 2.

The payer 115 registers the financial instrument from which the payment transaction is to be made, as shown in FIG. 4(c) by providing the authentication information of the financial instrument, particularly:

Card Number (409): 4824 4512 6589 7820

Name on Card (411): John Lucas

Expiry Date (413): 03/2017

CCV (415): 034

A portion of the authentication information is stored in the mobile phone 103 for later use, particularly, in the SIM or memory card of the mobile phone 103. The portion of authentication information may be the last four digits of the card number, i.e., “7820”.

The portion of the authentication information of the financial instrument may also be carried on a medium other than the mobile phone 103. For example, the portion of the authentication information may be embedded in a computer-readable mark that is printed on a piece of paper kept by the payer 115, for example, a barcode. The portion of the authentication information may also be stored on a computer-readable medium from which the portion of the authentication information may be read via for example Near Filed Communication (NFC) technologies.

The remaining portion of the authentication information of the financial instrument, for example, the first twelve digits of the card number (“4824 4512 6589”), the name on card (“John Lucas”), the expiry date (“03/2017”), and CCV (“034”), is sent from the mobile phone 103 to the payment server 105 for storage in the “Financial Instrument Authentication Information” field 203 of the account 200, as show in FIG. 2.

The payer 115 may register more than one financial instruments associated with the account 200, one of which is designated by the payer 115 to be the one used for the current payment.

Once the payer 115 registers the financial instrument with the payment sever 105, the payer 115 can start using the payment services provided by the payment server 105.

It should be noted that although the financial instrument is a credit card in this example, the financial instrument can be a debit card, a virtual card, a store card, a bank account, ACH, a Paypal account, an eMoney account, an eWallet, an mWallet, a bitcoin wallet, or other currency wallet.

Although the portion of authentication information is the last four digits of the card number in this example, the way of splitting the authentication information into portions may vary. Take the account 209 in the database 107 as an example, the portion of the authentication information that is the stored in the mobile phone 103 includes the last four digits of the card number and the last digit of CCV. Correspondingly, the remaining portion of the authentication information that is sent to the payment server 105 for storage includes the first twelve digits of the card number (“1664 4866 1168”), the name on card (“Ellen Johns”), the expiry date (“08/2018”), and the first two digits of CCV (“98”), as shown in FIG. 2. Take the account 211 in the database 107 as a further example, the portion of the authentication information that is the stored in the mobile phone 103 includes the last four digits of the card number and the month of the expiry date. Correspondingly, the remaining portion of the authentication information that is sent to the payment server 105 for storage includes the first twelve digits of the card number (“1689 8431 9432”), the name on card (“Angela Scofield”), the year of the expiry date (“2017”), and the CCV (“301”), as shown in FIG. 2.

Further, depending on the type of the financial instrument, the portion of the authentication information of the financial instrument stored in the mobile phone 103 may be different. For example, if the financial instrument is a Paypal account, the portion of the Paypal account may be part of the email address identifying the Paypal account.

Determining the Portion of Authentication Information of the Financial Instrument (310)

As described above, the portion of the authentication formation of the financial instrument may be stored in the SIM of mobile phone 103 or carried on a medium other than the mobile phone 103.

When making a payment, the mobile phone 103 may determine the portion of the authentication information of the financial instrument by retrieving the portion of the authentication information from the SIM of mobile device 103, which in this example is the last four digits of the card number of the financial instrument, “7820”.

In the case that the portion of the authentication information is carried on a medium other than the mobile phone 103, the mobile phone 103 may determine the portion of the authentication information via a user interface with the medium. For example, if the portion of the authentication information is stored in a Near Field Communication (NFC) tag, the mobile phone 103 may determine the portion of the authentication information by receiving the portion of the authentication information from a NFC interface installed thereon. In another example, the portion of the authentication information may not be stored in any computer-readable medium, but remembered by the payer 115. The mobile phone 103 may determine the portion of the authentication information by being provided with a keyboard for the payer 115 to enter the portion of the authentication information. In another example, the portion of the authentication information is contained in a computer-readable mark, particularly, a barcode or a QR code, the mobile phone 103 may determine the portion of the authentication information by using an optical reader to recognise the portion of the authentication information from the computer-readable mark. The optical reader includes a camera installed on the mobile phone 103 that operates with an appropriate application running on the mobile phone 103.

Receiving Transaction Information Associated with the Transaction (320)

When the payer 115 makes a payment to the payee 117 for the goods or services purchased, the payer 115 sends a request to the payee 117. In response to the request, the payee 117 generates the token 119 for the payer 115. The token 119 contains transaction information of the payment transaction, for example, details of all products or services purchased by the payer 115, the amount of money, and the payee's 117 financial institution information.

The transaction information may further include augmented reality data, transmitted optically or wirelessly as it relates to the product or service being purchased, the payee's 117 contacts information, promotional offers, an invoice number, images of the products, product specifications, manufacturer information, etc.

The token 119 may be a computer-readable mark in which the transaction information is coded, as shown in FIG. 1. The computer-readable mark is printed or projected on a medium. For example, the token 119 may be a barcode or a Quick Response (QR) Code. The barcode or QR code may be printed on a material such as a piece of paper, a flyer and a card. The barcode or the QR code may also be projected onto a device, for example, a screen, to be recognized by the mobile phone 103 of the payer 115. The computer-readable mark may also be displayed on a web page, or included in a mobile application, a web application. The token 119 may take other forms without departing from the scope of the present disclosure.

The mobile phone 103 may scan the computer-readable mark for the transaction information by using an optical interface 417, as shown in FIG. 4(d). The optical interface includes, for example, a camera installed on the mobile phone 103 that operates with an appropriate application running on the mobile phone 103.

The token 119 can be a message containing the transaction information sent to the payer 115 via a wireless cellular network, Internet, a wireless area network (WLAN), Bluetooth, an online streaming service, or a combination thereof. The message containing the transaction information may be a short message sent to the payer 115 via Short Message Service (SMS) or a multimedia message sent via Multimedia Message Service (MMS) provided by a cellular telephone network, an instant message sent via an Over-The-Top (OTT) application, for example, Whatsapp, iMessage, or an instant message sent via social networks such as Facebook, Twitter, and LinkedIn. The message may also be an electronic mail (E-mail) send to the payer 115 via Internet. The message may also be metadata containing the transaction information. Upon receipt of the message containing the transaction information, the mobile phone 103 extracts the transaction information from the message.

The token 119 containing the transaction information may reside in a Radio Frequency Identification (RFID) tag or a NFC tag provided by the payee 117 at points of sale. In this case, the token 119 may be obtained by using a RFID interface 419 or a NFC interface 421 on the mobile phone 103 to scan the tag, as shown in FIG. 4(d). For example, the a first RFID tag is attached to a pair of shoes and a second RFID tag is attached to a washing machine. Theses tags contains products information such as price, manufacture, coupon, and payee's 117 information, etc. The payer 115 receives the production information by scanning these tags using the RFID interface 419 of the mobile phone 103.

Once the transaction information is obtained at the mobile phone 103, the transaction information is presented to the payer 115, as shown in FIG. 4(e). If the transaction information includes the augmented data, the augmented data is also presented to the payer 115. As can be seen from FIG. 4(e), the description, quantities, prices of the products and the total amount of money in relation to the payment are shown on the screen of the mobile phone 103.

The method 300 may allow the payer 115 to change at least some of the transaction information before making the payment. In an example, the payer 115 is able to add more products to or delete products from the transaction, or to change the quantity of the product the payer 115 wants to purchase. In another example, the payer 115 is able to provide the payee 117 with a delivery address for the product, which may or may not be stored by the payment server 103 in the user database 107.

In this example, the transaction information is generated in response to the purchase activities by the payer 115. In other examples, the transaction information is generated and broadcasted to potential online or in-store customers, for example, donation information 431, promotional information 433. The payer 115 listens to the transaction information online or in store that is broadcasted to the customers via various technologies 435, for examples, Digital Audio Broadcasting (DAB), Digital Video Broadcasting (DVB) or online streaming services, as shown in FIG. 4(h). The payer 115 selects one or more of offers 433 and makes payments as shown in FIG. 4(e). This provides a fast checkout experience.

In another example, the transaction information includes an transaction identifier (ID) associated with details of the transaction as described above, for example, details of all products or services purchased by the payer 115, the amount of money, and the payee's 117 financial institution information. The transaction ID is sent from the payee 117 to the payer 115, and the associated details of the transaction are sent from the payee 117 to the payment server 105.

Sending Payment Information to a Payment Service Processor (330)

When the payer 115 decides to make the payment for these products or services, the payer 115 clicks on the “Pay Now” 423 as shown in FIG. 4(e). The mobile phone 103 sends a payment request to the payment server 105. The payment request may include payment information associated with the payment transaction. The payment information includes the portion (“7820”) of the authentication information of the financial instrument and the transaction information. The payment information may also include the phone number (“+1 123 456 789”) of the mobile phone 103 for the payment server 105 to identify the account 200 associated with the payer 115 in the user database 107.

The phone number of the mobile phone 103 securely associated with the payer 115 is a unique ID of the account 200. Therefore, the phone number is sufficient for the payer 115 to access the account 200. Since the phone number is automatically included in the payment information, the payer 115 does not need to manually enter the phone number and provide other information to the payment server 105, which dramatically reduces time spent on data entry and provides a fast checkout experience.

In another example, the payer 115 may be prompted to provide the user authentication, for example, the user name and the password or the biometrics information of the payer 115, to access the account 200.

Further, the additional data, for example, location data, may be provided to the payment server 105 to reduce fraud risk. The location data may be automatically detected by the Global Positioning System (GPS) installed on the mobile phone 103 or according to the IP address of the mobile phone 103. The user authentication provided by the payer 115 and the additional data detected are also included in the payment information.

If the payment is successful, the payment server 105 or the authentication network 109 sends a message to the mobile phone 103 of the payer 115 indicating that the payment has been successfully made to the payee's 117 financial institution 113 and a reference number 425 is given to the payer 115, as shown in FIG. 4(f). The authentication network 109 may also send a notification to the payee 117 that the payment is successfully made.

Depending on the setting of the account 200 at the payment server 105, the payment may be split into multiple sub-payments. In this case, the payer 115 needs to provide the amount of each sub-payment 427, 429 to indicate that payer 115 is authorised to use the financial instrument, as detailed in U.S. Pat. No. 8,620,810. The payer 115 obtains the sub-payment information from an account of the financial instrument or a statement issued for the financial instrument. The account or the statement is only accessible by the payer 115 or other users with the authorisation from the payer 115. Once the amount of the each sub-payment is confirmed, the payee 117 delivers or releases the products to the payer 115.

It should be noted although the method 300 in this example is described as an independent application running on the mobile phone 103, the method 300 can integrated into a third-part application, for example, an E-commerce website. The method 300 is invoked when the payer 115 makes payments on the website.

Description of an Example Method for Making a Payment Transaction

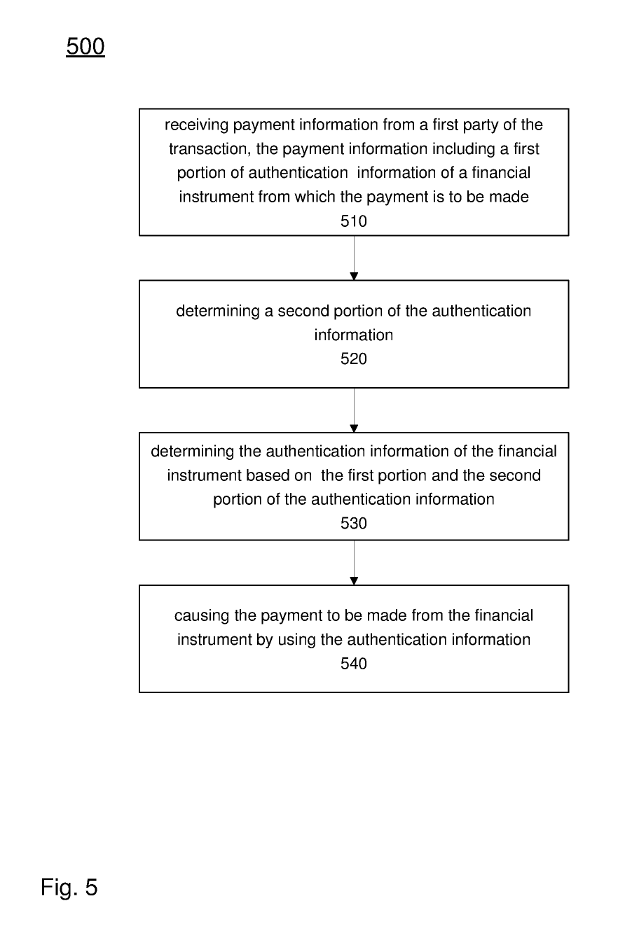

FIG. 5 illustrates an example method 500 for making a payment transaction, which may be performed on the payment server 105. As shown in FIG. 5, the method 500 receives 510 the payment request including payment information from a first party of the transaction. The payment information includes the portion of authentication information of the financial instrument from which the payment is to be made. The method 500 further determines 520 the remaining portion of the authentication information. Based on the portion of the authentication information and the remaining information of the authentication information, the method 500 determines 530 the authentication information of the financial instrument. The method 500 sends the authentication information to the authentication network 109 to authenticate the financial instrument. If the authentication information sent from the payment server 105 is authenticated by the authentication network 109, the payment is caused 540 to be made from the payer's financial institution 111 to the payee's financial institution 113.

A detailed example implementation of the method 500 is described below.

Creating an Account in the User Database 107

As described above with reference to FIGS. 4(a) to (c), the payment server 105 creates the account 200 associated the payer 115 in the user database 107 during the registration of the payer 115 with the payment server 105.

The account 200 is identified by identification information of the mobile phone 103, particularly, the phone number 410 (“+1 123 456 789”) of the mobile phone 103 in this example. In other examples, the account 200 may be identified by the other information without departing form the present disclosure.

Upon receipt of the phone number 401 provided by the payer 115, the payment server 105 checks if the phone number has been registered in the database 107. If the phone number 401 has been used, the payment sever 105 prompts to the payer 115 to use another phone number or overwrite the account associated with the phone number 401.

Upon receipt of the request 403 for the OTP, the payment server 105 may generate the OTP or instruct a third party, for example, Google Authenticator, to generate the OTP. The OTP is sent to the mobile phone 103 of the payer 115 according to the phone number 401 provided by the payer 115 to verify the ownership of the mobile phone 103.

Once the ownership of mobile phone 103 is verified, the payment server 105 creates the accounts 200 for the payer 115 and stores the phone number 401 (“+1 123 456 789”) of the payer 115 in the “User ID” field 201 of the account 200, as shown in FIG. 2.

As described above, the payment server 105 may receive the authentication information of the payer 115 for additional security from the mobile phone 103. The authentication information in this example is a combination of the user name (“John Lucas”) and the password (“jhnlucs”). The authentication information can also be biometrics information of the payer 115 or other information that is able to identify the payer 115 without departing from the scope of the invention. Upon receipt of the authentication information, the payment server 105 associates the account 200 with the authentication information of the payer 115 by for example storing the authentication information in the “User Authentication” field 205, as shown in FIG. 2. The authentication information of the payer 115 may be a OTP. In this case, the OTP may be generated in association with the account 200 as needed and may not be stored in the “User Authentication” field 205.

As described above, the payment server 105 may receive the additional data (“CA, US”) from the mobile phone 103 to reduce fraud risks. Upon receipt of the additional data, the payment server 105 associates the account 200 with the additional data, particularly, location data, by for example storing the additional data in the “Additional Data” field 207 of the account 200, as shown in FIG. 2.

As described above, when the payer 115 registers the authentication information of the financial instrument with the account 200, the mobile phone 103 stores the portion of the authentication information of the financial instrument, while the remaining portion of the authentication information is sent to the payment server 105.

Upon receipt of the remaining portion of the authentication information from the mobile phone 103, the first twelve digits of the card number (“4824 4512 6589”), the name on card (“John Lucas”), the expiry date (“03/2017”) and CCV (“034”), the payment server 105 associates the account 200 with the remaining portion of the authentication information of financial instrument by for example storing the remaining portion of the authentication information in the “Financial Instrument Authentication Information” field 203 of the account 200, as show in FIG. 2.

It should be noted that the account 200 may be structured in a way other than what is shown in FIG. 2. For example, the account 200 may include a “Contacts” field (not shown in FIG. 2). The “Contacts” field contains the contacts of payer 115. During registration of the payer 115 with the payment server 103, the payer 115 may enable access by the present disclosure to the contacts that are stored on the mobile phone 103.

Contact information of a contact includes for example, a name, a phone number or an E-mail address of the contact. The contact information is provided to the payment server 103 and stored in the “Contacts” field. The payment server 103 sends a message via a short message or an E-mail to one or more contacts of the payer 115 to invite these contacts to register with the payment sever 103. Upon receipt of the message, the one or more contacts may register themselves with the payment server 105 as described with reference to FIG. 4(a) to (c). As a result, one or more accounts may be established in the user database 107 for the one or more contacts of the payer 115.

Receiving Payment Information from a First Party of the Transaction (510)

The payment server 105 receives the payment request including the payment information from the payer 115, particularly, the mobile phone 103 of the payer 115. As described above, the payment information includes the phone number (“+1 123 456 789”) of the mobile phone 103, the portion (“7820”) of the authentication information of the financial instrument, and transaction information associated the transaction. The payment server 105 extracts, from the payment information, the phone number of the mobile phone 103, the portion of the authentication information of the financial instrument and the transaction information. If the transaction information is the transaction ID, the payment server 105 obtains the associated details of the transaction sent from the payee 117 according to the transaction ID.

The payment sever 105 searches the user database 107 by the phone number (“+1 123 456 789”) and identifies the account 200 that is associated with the phone number, as shown in FIG. 2. In an example, the phone number of the mobile phone 103 is the only requirement for the payer 115 to access the account 200. As a result, access to the account 200 identified by the phone number is allowed without further information provided.

In another example, the authentication information of the payer 115 is required to access the account 200, the payment server 105 extracts the authentication information of the payer 115 from the payment information, i.e., the user name (“John Lucas”) and the password (“jhnlucs”). In a further example, the additional data is required to assess fraud risks, the payment server 105 further extracts the additional data from the payment information, i.e., location data (“CA, US”).

Determining a Second Portion of the Authentication Information (520)

Once the account 200 associated with phone number of the mobile phone 103 is identified, the payment server 105 then determines the remaining portion of the authentication information of the financial instrument by retrieving these information from the “Financial Instrument Authentication Information” field 203 of the account 200. As shown in FIG. 2, the remaining portion of the authentication information of the financial instrument includes the first twelve digits of the credit card (“4824 4512 6589”), the expiry date (“03/2017”), the name on the card (“John Lucas”), and the CCV (“034”) of the credit card.

If the authentication information of the payer 115 is required to access the account 200, the payment server 105 retrieves the authentication information of the payer 115 from the “User Authentication” field 205 and compares the authentication information retrieved from the “User Authentication” filed 205 and the authentication information extracted from the payment information. In this example, the authentication information of the payer 115 retrieved from the “User Authentication” field 205 matches the authentication information extracted from the payment information. Therefore, the payment server 115 allows access to the account 200. In this example, the authentication information of the payer 115 is a combination of a user name and a password. In other example, the authentication information of the payer 115 may be biometrics information of the payer 115.

In a further example, the authentication information of the payer 115 may be a OTP. In this case, the payment server 105 generates or instructs a third-party to generate the OTP. The OTP is then sent to the mobile phone 103 of the payer 115. The payer 115 is prompted to provide the OTP sent to the mobile phone 103. If the OTP provided by the payer 115 matches the OTP generated, the payment server 115 allows access to the account 200.

If the additional data is required to assess fraud risks, the payment server 105 retrieves the additional data from the “Additional Data” field 207 of the account 200, which is location data in this example. The payment server 105 compares the location data retrieved from the “Additional Data” field 207 and the location data extracted from the payment information to determine a risk level. In this example, since the location data retrieved from the “Additional Data” field 207 of the account 200 is “CA, US”, and the location data extracted from the payment information is “CA, US” as well, which means the risk level is low. In this case, the payment server 105 allows access to the account 200. Otherwise, the payment server 105 may not allow access to the account 200 because the location where the payer 115 normally makes payments is different to the location where the payer 115 is making the payment, which means that the mobile phone 103 of the payer 115 may be stolen and used in another geographic area.

Determining the Authentication Information of the Financial Instrument (530)

The payment server 105 determines the authentication information of the financial instrument by combining the portion of the authentication information received from the mobile phone 103 and the remaining portion of the authentication information obtained from the “Financial Instrument Authentication Information” field 203 of the account 200. As a result, the authentication information of the financial instrument is determined as follows:

Card Number: 4824 4512 6589 7820

Name on Card: John Lucas

Expiry Date: 03/2017

CCV: 034

It should be noted that the way of combining the portions of the authentication information depends on the way of splitting the authentication information as described above.

Causing the Payment to be Made from the Financial Instrument (540)

The payment server 105 sends the authentication information along with the transaction information to the authentication network 109. If the authentication process is successful, the amount of money included in the transaction information is debited from the payer's financial institution 111 to the payee's financial institution 113.

In another example, the payment server 103 determines whether the payer 115 is authorised to the use financial instrument. For example, the amount of money is split into multiple sub-payments, which results in multiple sub-payment for the single payment transaction. The total amount of the multiple sub-payments is equal to the amount of money of the payment transaction. This results in multiple transaction records for the payment transaction in the account of the financial instrument or the statement issued for the financial instrument. The multiple sub-payments may be required for the payee 117 to deliver or release the products to the payer 115, as shown in FIG. 4(g). This process is detailed in the U.S. Pat. No. 8,620,810. Further, the process described in the European Patent No. 1356438 may also be used by the payment sever 103 to determine the authorisation of the payer 115. The payment server 103 may use other mechanisms to determine the authorisation of the payer 115 without departing from the present disclosure.

Hardware Description

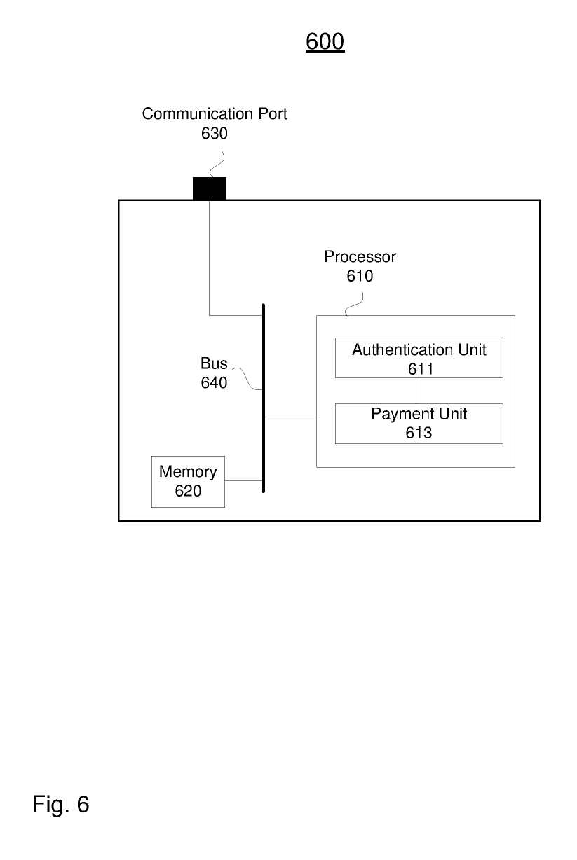

FIG. 6 illustrates an example schematic diagram of a computer system 600 used to implement the example methods described above with reference to the mobile phone 103. The computer system 600 may be part of the mobile phone 103.

The computer system 600 includes a processor 610, a memory 620, a communication port 630 and a bus 640. The processor 610, the memory 620, the communication port 630 are connected through the bus 640 to communicate with each other.

The processor 610 performs instructions stored in the memory 620 to implement the example methods described above with reference to the mobile phone 103.

The processor 610 further includes, an authentication unit 611 and an payment unit 613. The units 611 and 613 of the processor 610 are organised in a way shown in FIG. 6 for illustration and description purposes only, which may be arranged in a different way. Specifically, one or more units in the processor 610 may be part of another unit. For example, the authentication unit 611 may be integrated with the payment unit 613. In another example, the authentication unit 611 in the processor 610 may be separate from the processor 610 without departing from the scope of the present disclosure.

The communication port 630 of the computer system 300 receives transaction information associated with the transaction. As describe above, the transaction information is contained in the token 119 generated by the payee 117. The transaction information includes, details of all products or services purchased by the payer 115, the amount of money, the payee's 117 financial institution information.

The communication port 630 may be an Internet interface, a WLAN interface, a cellular telephone network interface, a RFID interface, a NFC interface, or an optical reader to receive or recognise the token 119 generated by the payee 119, as described above.

The authentication unit 611 of the process 610 determines a portion of authentication information of a financial instrument from which the payment is to be made. The authentication unit 611 may reuse the communication port 630 to obtain the portion of authentication information of the financial instrument. In the example describe above, the first portion of the authentication information of the financial instrument is the last four digits of the card number, i.e., “7820”.

The payment unit 613 of the processor 610 sends payment information including the portion of authentication information and the transaction information to a payment service processor to determine the authentication information of the financial instrument and cause the payment to be made from the financial instrument. The payment unit 613 may reuse the communication port 630 to send the payment information to the payment service processor. The payment service processor may be implemented as the payment server 105 described above.

The computer system 600 may further include a display interface (not shown in FIG. 6) to connect with a display. Interaction information is presented on the display to prompt the payer 115 to interact with the computer system 600.

The memory 620 stores other instructions, when performed by the processor 610, causing the processor 610 to implement other examples described with reference to the mobile phone 103.

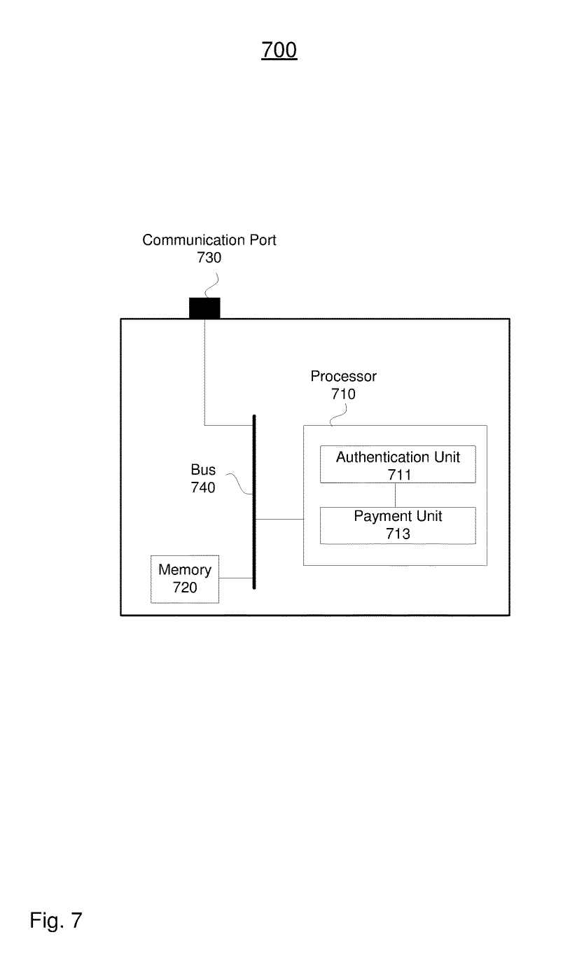

FIG. 7 illustrates an example schematic diagram of a computer system 700 used to implement the example methods described above with reference to the payment server 105.

The computer system 700 includes a processor 710, a memory 720, a communication port 730 and a bus 740. The processor 710, the memory 720, the communication port 730 are connected through the bus 740 to communicate with each other.

The processor 710 performs instructions stored in the memory 720 to implement the example methods described above with reference to the payment server.

The processor 710 further includes an authentication unit 711 and an payment unit 713. The units 711 and 713 of the processor 710 are organised in a way shown in FIG. 7 for illustration and description purposes only, which may be arranged in a different way. Specifically, one or more units in the processor 710 may be part of another unit. For example, the authentication unit 711 may be integrated with the payment unit 713. In another example, the authentication unit 711 in the processor 710 may be separate from the processor 710 without departing from the scope of the present disclosure.

The communication port 730 of the computer system 300 receives payment information from a first party of the transaction, the payment information including a first portion of authentication information of a financial instrument from which the payment is to be made. As describe above, the first party of the transaction is the payer 115 and first portion of the authentication information is the last four digits of card number, i.e., “7820”. The payment information may further include the phone number (“+1 123 456 789”) of the payer 115. As described above, the transaction information includes details of all products or services purchased by the payer 115, the amount of money, the payee's 117 financial institution information.

Based on the phone number of the payer 115, the processor 710 identifies the account 200 associated with the payer 115. The authentication unit 711 of the processor 710 further determines a second portion of the authentication information from the account 200 as described above. Based on the first portion and the second portion of the authentication information, the authentication unit 711 determines the authentication information of the financial instrument.

The payment unit 713 of the processor 710 sends the authentication information of the financial instrument to the authentication network 109. If the financial instrument is authenticated by the authentication network 109, the payment is made from the payer's financial institution 111 to the payee's financial institution 113.

The memory 720 stores other instructions, when performed by the processor 710, causing the processor 710 to implement other examples described with reference to the payment sever 105.

It should be understood that the example methods of the present disclosure might be implemented using a variety of technologies. For example, the methods described herein may be implemented by a series of computer executable instructions residing on a suitable computer readable medium. Suitable computer readable media may include volatile (e.g. RAM) and/or non-volatile (e.g. ROM, disk) memory, carrier waves and transmission media. Exemplary carrier waves may take the form of electrical, electromagnetic or optical signals conveying digital data steams along a local network or a publically accessible network such as internet.

It should also be understood that, unless specifically stated otherwise as apparent from the following discussion, it is appreciated that throughout the description, discussions utilizing terms such as “determining”, “obtaining”, or “receiving” or “sending” or “authenticating” or the like, refer to the action and processes of a computer system, or similar electronic computing device, that processes and transforms data represented as physical (electronic) quantities within the computer system's registers and memories into other data similarly represented as physical quantities within the computer system memories or registers or other such information storage, transmission or display devices.

1. A computer-implemented method for making a payment transaction, said method comprising:
receiving payment information from a first party of the transaction, the payment information including a first portion of authentication information of a financial instrument from which the payment is to be made;
determining a second portion of the authentication information;
determining the authentication information of the financial instrument based on the first portion and the second portion of the authentication information; and
causing the payment to be made from the financial instrument by using the authentication information.

2. The computer-implemented method according to claim 1, wherein the first party of the transaction is a payer of the transaction and receiving the payment information comprises receiving the payment information from a mobile device securely associated with the payer.

3. (canceled)

4. The computer-implemented method according to claim 2, further comprising:
establishing an account associated with the payer, the account being identified by identification information of the mobile device; and
associating the account with the second portion of the authentication information of the financial instrument.

5. The computer-implemented method according to claim 4, further comprising:
receiving a request for access to the account to make the payment, the request including the identification information of the mobile device;
allowing access to the account identified by the identification information of the mobile device.

6. (canceled)

7. The computer-implemented method according to claim 4, further comprising:
associating the account with location data for use in assessing fraud risk;
receiving location data indicating a geographic location of the mobile device;
determining a risk level based on the received location data and the location data associated with the account.

8-9. (canceled)

10. The computer-implemented method according to claim 1, wherein determining the authentication information of financial instrument comprises combining the first portion with the second portion of the authentication information of financial instrument.

11. (canceled)

12. A computer-implemented method for making a payment transaction, said method comprising:
determining a portion of authentication information of a financial instrument from which the payment is to be made;
receiving transaction information associated with the transaction;
sending payment information including the portion of authentication information and the transaction information to a payment service processor to determine the authentication information of the financial instrument and cause the payment to be made from the financial instrument.

13. The computer-implemented method according to claim 12, wherein determining the portion of the authentication information comprises retrieving the portion of the authentication information from a mobile device securely associated with a user of the financial instrument.

14. The computer-implemented method according to claim 12, wherein determining the portion of the authentication information comprises receiving the portion of the authentication information from a user interface.

15. The computer-implemented method according to claim 12, wherein receiving the transaction information comprises obtaining the transaction information from a message.

16. (canceled)

17. The computer-implemented method according to claim 12, wherein receiving the transaction information comprises obtaining the transaction information from a token in which the transaction information is coded.

18. The computer-implemented method according to claim 17, wherein the token is a computer-readable mark presented on a medium.

19. The computer-implemented method according to claim 18, wherein obtaining the transaction information comprises scanning the computer-readable mark for the transaction information.

20. The computer-implemented method according to claim 18, wherein the medium comprises:
a screen on which the computer-readable mark is displayed; and
a material on which the computer-readable mark is printed or projected.

21. The computer-implemented method according to claim 17, wherein the token is generated by a payee of the transaction.

22. The computer-implemented method according to claim 12, wherein the transaction information comprises augmented reality data.

23. The computer-implemented method according to claim 22, further comprises:
obtaining the augmented reality data from the transaction information; and
presenting the augmented reality data to a user of the financial instrument.

24. A computer system for making a payment transaction, the computer system comprises:
a communication port to receive payment information from a first party of the transaction, the payment information including a first portion of authentication information of a financial instrument from which the payment is to be made; and
a processor comprises:
an authentication unit to
determine a second portion of the authentication information the financial instrument; and
determine the authentication information of the financial instrument based on the first portion and the second portion of the authentication information; and
a payment unit to cause the payment to be made from the financial instrument by using the authentication information.

25. A computer system for making a payment transaction, the computer system comprises:
a communication port to receive transaction information associated with the transaction; and
a processor comprises:
an authentication unit to determine a portion of authentication information of a financial instrument from which the payment is made; and
a payment unit to send payment information including the portion of authentication information and the transaction information to a payment service processor to determine the authentication information of the financial instrument and cause the payment to be made from the financial instrument.

26. A non-transitory computer-readable medium including computer-executable instructions stored thereon that when executed by a processor causes the processor to perform the method of claim 1.

27. A non-transitory computer-readable medium including computer-executable instructions stored thereon that when executed by a processor causes the processor to perform the method of claim 12.
